(19) United States
(12) Patent Application Publication
(10) Pub. No.: US 2008/0215570 A1
(43) Pub. Date: Sep. 4, 2008

(54) Medical literature database search tool

(76) Inventors: Alan G. Maloney, San Francisco, CA (US); Brian J. Goldsmith, Folsom, CA (US)

Correspondence Address: WILSON SONSINI GOODRICH & ROSATI, 650 PAGE MILL ROAD, PALO ALTO, CA, 94304-1050, US

(21) Appl. No.: 11/985,382

(22) Filed: Nov. 14, 2007

Related U.S. Application Data
(63) Continuation of application No. 10/779,569, filed on Feb. 13, 2004.
(60) Provisional application No. 60/512,337, filed on Oct. 17, 2003.

(51) Int. Cl. G06F 7/10; G06F 17/30

(52) U.S. Cl. 707/5; 707/E17.017

(57) ABSTRACT

This invention provides a method of identifying clinically relevant, evidence based medical literature on diseases and their treatment to physicians, nurses and other healthcare personnel. This method accesses a medical literature database that is then searched using a medical literature classification system identifier for a disease integrated with an evidence based medicine search filter. In conjunction with identifying the evidence based medical literature, a database of articles selected and reviewed by experts that concern the disease is also searched. The results of both searches are then displayed to the user. This invention can be implemented through the use of an encoded computer readable medium.

### CROSS-REFERENCE

This application is a continuation of Ser. No. 10/779,569, filed Feb. 13, 2004, which claims the benefit of U.S. Provisional Application No. 60/512,337, filed Oct. 17, 2003, all of which are incorporated herein by reference in its entirety.

### BACKGROUND OF THE INVENTION

While there is an ever increasing volume of medical literature in general, physicians feel increasingly time constrained. Further, barriers to the use of medical literature covering evidence-based medicine in particular include time constraints, a lack of exposure, unavailable resources, and cost. Moreover, the low level use of evidence-based medicine resources by physicians is a clinical problem relevant to improving public health. The benefits to healthcare providers, patients, and researchers alike of facilitating retrieval of the most current, most high-quality medical papers available are unquestionable.

Therefore, there is a need for retrieval of highly relevant medical literature for time-constrained physicians.

### SUMMARY OF THE INVENTION

In some embodiments, disease classification system identifiers are received; disease classification system identifiers are translated into medical literature classification system identifiers; a medical literature database is filtered based on relevance to evidence-based medicine; and medical literature articles are identified from a medical literature database based on medical literature classification system identifiers. Various embodiments add, delete, and modify portions of the claimed methods and apparatuses.

In other embodiments, genetic profiles of patients are received; genetic profiles are translated into medical literature classification system identifiers; a medical literature database is filtered based on relevance to evidence-based medicine; and medical literature articles are identified from a medical literature database based on medical literature classification system identifiers. Various embodiments add, delete, and modify portions of the claimed methods and apparatuses. Some embodiments include code on a computer readable medium.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a flowchart of a method of identifying medical literature.

FIG. 2 shows a diagram of a physical implementation for identifying medical literature.

FIG. 3 shows another flowchart of a method of identifying medical literature.

FIG. 4 shows an example of an interface with a selector for an evidence based medicine filter and a selector for a disease classification system identifier.

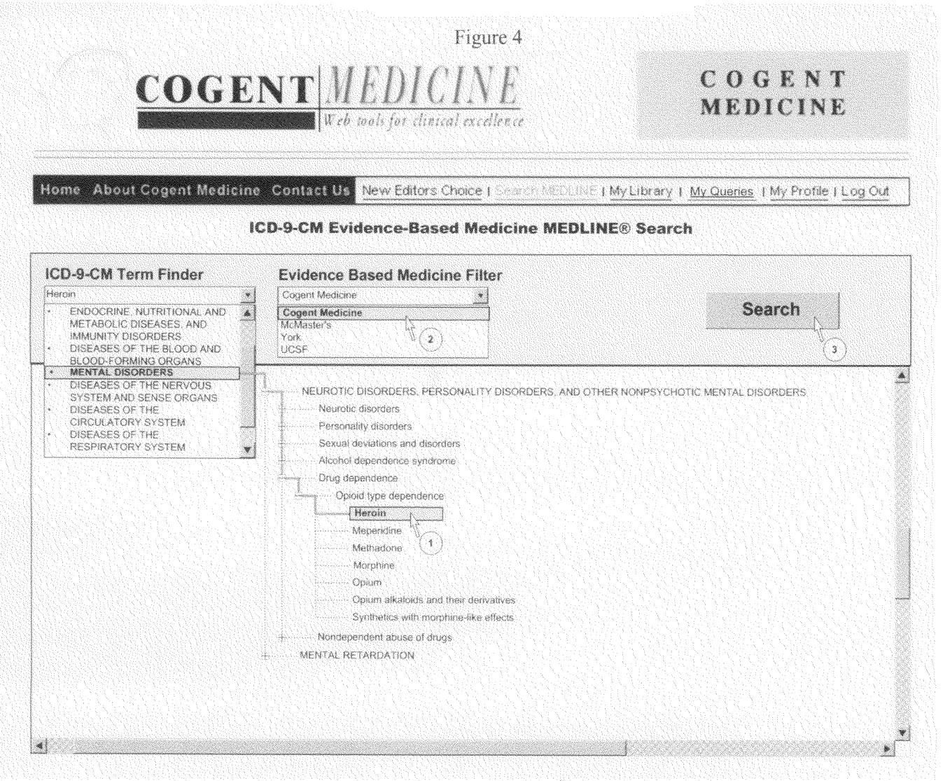

FIG. 5 shows an example of an interface with search results.

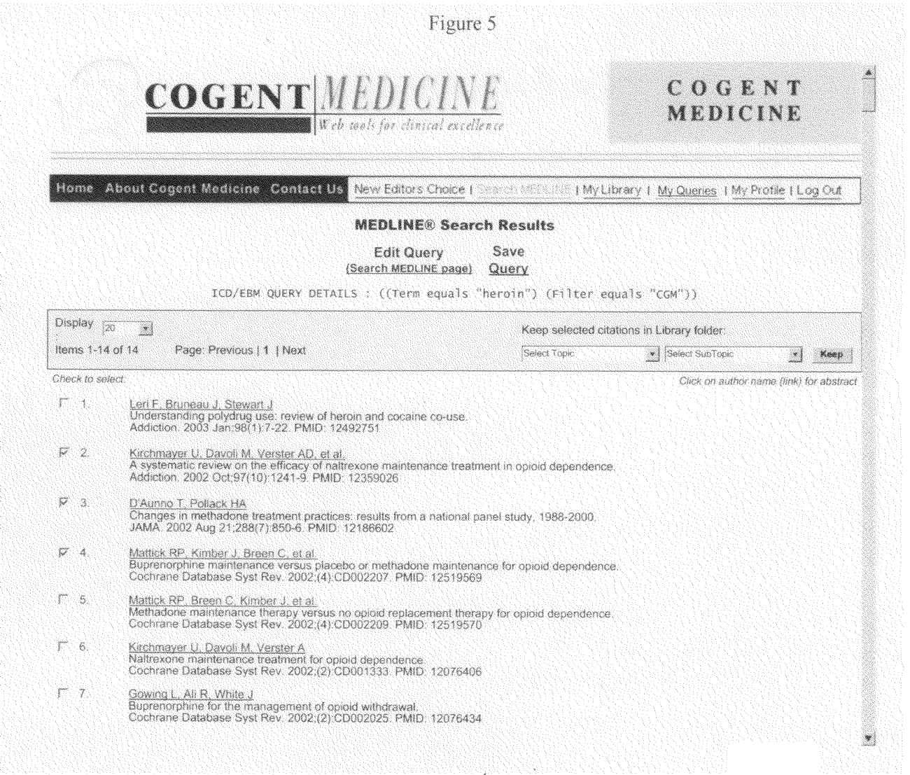

FIG. 6 shows an example of an interface with a selected citation.

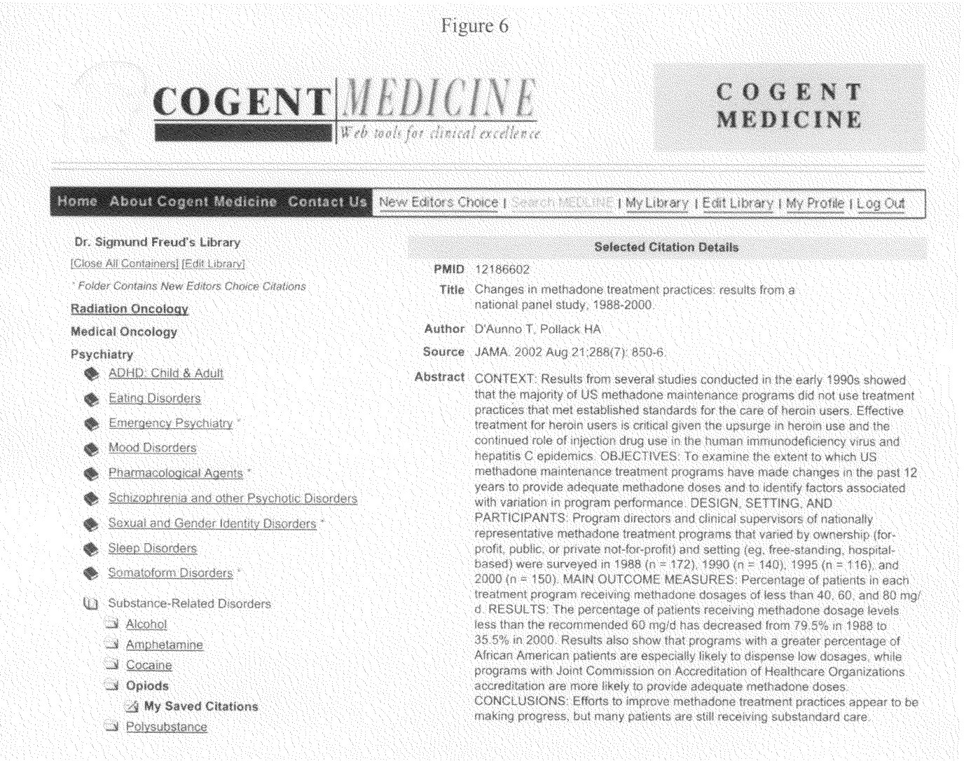

### DETAILED DESCRIPTION OF THE INVENTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

While there is an ever increasing volume of medical literature in general, physicians feel increasingly time constrained. In the face of this time pressure, practicing physicians have little time to stay current with the medical literature. According to some surveys, physicians report that they read peer-reviewed literature for 1 to 3 hours per week. Results of such surveys may even overestimate the amount of time spent reading peer-reviewed literature because of a tendency to overestimate self-reported numbers.

Barriers to the use of evidence-based medical literature in particular include time constraints, a lack of exposure, unavailable resources, and cost. The insufficient use of evidence-based medicine resources is a clinical problem relevant to improving public health. Failing the wider availability of evidence-based medicine, patients may receive sub-optimal care. Moreover, information needs which delay or confuse clinical decisions are a significant cause of medical error.

In the face of increasing time constraints, healthcare providers cannot spend more time searching and reading the medical literature. Instead, an innovative mechanism can assist healthcare providers in the identification of particularly relevant the medical literature citations. This can be accomplished by a framework that is intuitively obvious to clinicians, married to an automated tool which identifies high-value medical literature citations. Such a framework can significantly lower the barrier to physicians' access to the medical literature, and thereby improve patient care.

Various embodiments provide healthcare providers access to artfully organized peer-reviewed literature. Patients and medical care providers benefit from facilitated retrieval of the most current, highest quality medical information available. Physicians will increase their use of the medical literature when provided a clinically intuitive interface that automates the identification of quality citations in the medical literature database.

Tools in this area involve state-of-the-art informatics used in production systems, integrated with features that are specifically designed to support practicing clinicians by facilitating their access to citations that are timely, relevant, and high-quality. Such tools can embody innovation in informatics (the back end) as well as information design (the front end).

Clinical informatics to ease clinical access to medical literature is greatly advanced by simplifying the access to clinically relevant literature. A front end for a disease classification system, or nosology, such as ICD-9-CM (International Classification of Diseases, Ninth Revision, Clinical Modification), can be combined with a medical database, such as the National Library of Medicine's (NLM's) MEDLINE® database of citations. In one example, this tool uses the ICD-9-CM diseases and procedures files as the lexical interface for searching MEDLINE®. ICD-9-CM can be linked to Medical Subject Headings (MeSH), a National Library of Medicine-maintained database of terms, which is the primary index for articles in the MEDLINE® database. Evidence-based medicine filters can be selected. By filtering citation records against specific combinations of MeSH terms related to publication features, citations qualifying as evidence-based medicine can be identified. The linkage of the disease classification system to evidence-based medicine helps manifest benefits for the practicing physician. An interface, such as a web interface, is made easy-to-use for medical professionals. Users can be charged or not charged.

Application U.S. Ser. No. 60/512,337, filed on Oct. 17, 2003 and Application U.S. Ser. No. 10/330,648, filed on Dec. 27, 2002 are incorporated by reference.

Such an approach to clinical informatics significantly lowers the barrier to physicians' access to medical literature. The focus on physician information needs and user experience, rather than on theoretical informatics, is innovative.

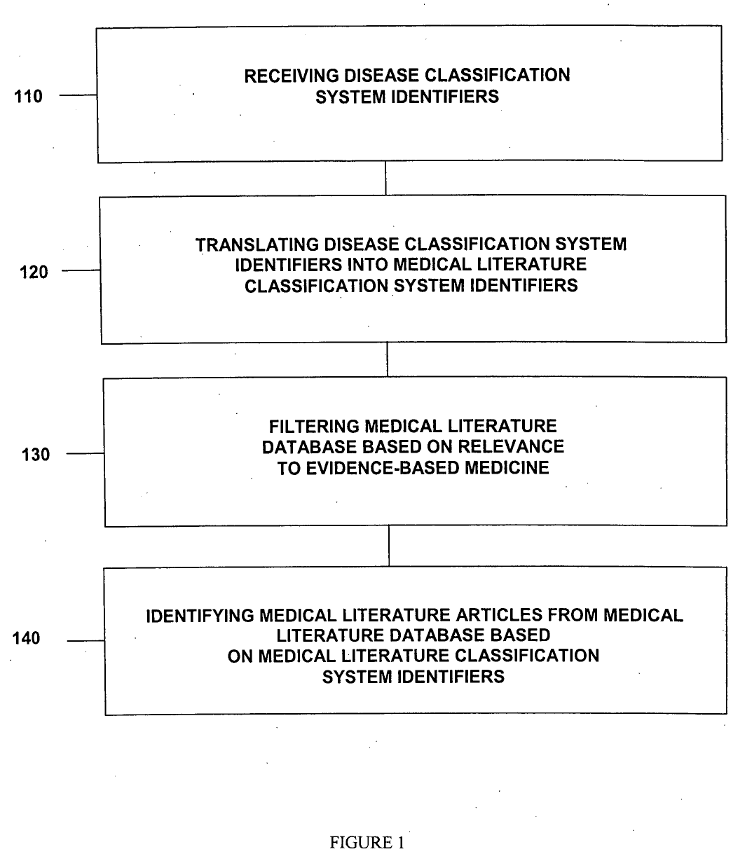

FIG. 1 shows an exemplary embodiment of identifying medical literature. In 110, disease classification system identifiers are received. In 120, disease classification system identifiers are translated into medical literature classification system identifiers. In 130, a medical literature database is filtered based on relevance to evidence-based medicine. In 140, medical literature articles are identified from a medical literature database based on medical literature classification system identifiers. Various details of some embodiments follow below. Various embodiments add, delete, and modify portions of the claimed methods and apparatuses.

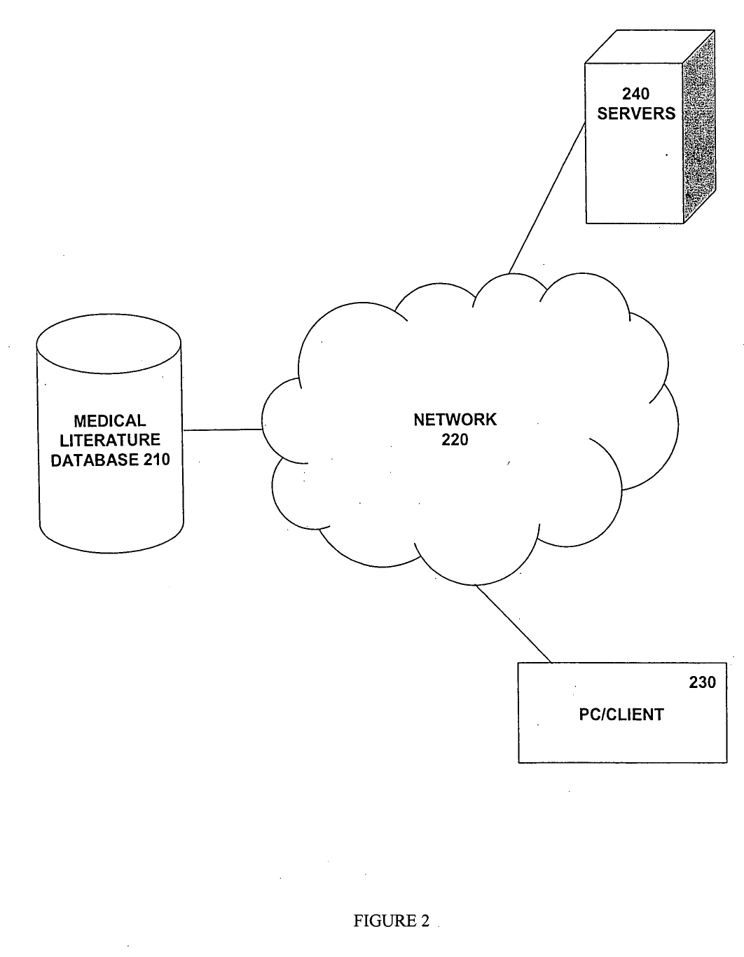

FIG. 2 shows an exemplary physical implementation of various embodiments. A medical literature database 210, a personal computer or other client 230, and servers 240 are coupled via a network 220. The network can be just one network, such as the Internet, a LAN, or a WAN, or a combination of multiple networks. Although the medical literature database 210, personal computer or other client 230, and servers 240 are shown at separated nodes on the network, they can be combined to share one or several network nodes. The medical literature database 210 can be one database or multiple databases. The personal computer or other client 230 may be a desktop, laptop, a handheld, or other computer client, or multiple such clients. The servers 240 can be a combination of network, application, and/or database servers communicating with the medical literature database 210 and personal computer or other client 230.

Some embodiments include code on a computer readable medium. The computer readable medium can be one or a combination of memory, processor, hard disk, CD, DVD, floppy, carrier wave traveling a wired and/or wireless network, etc.

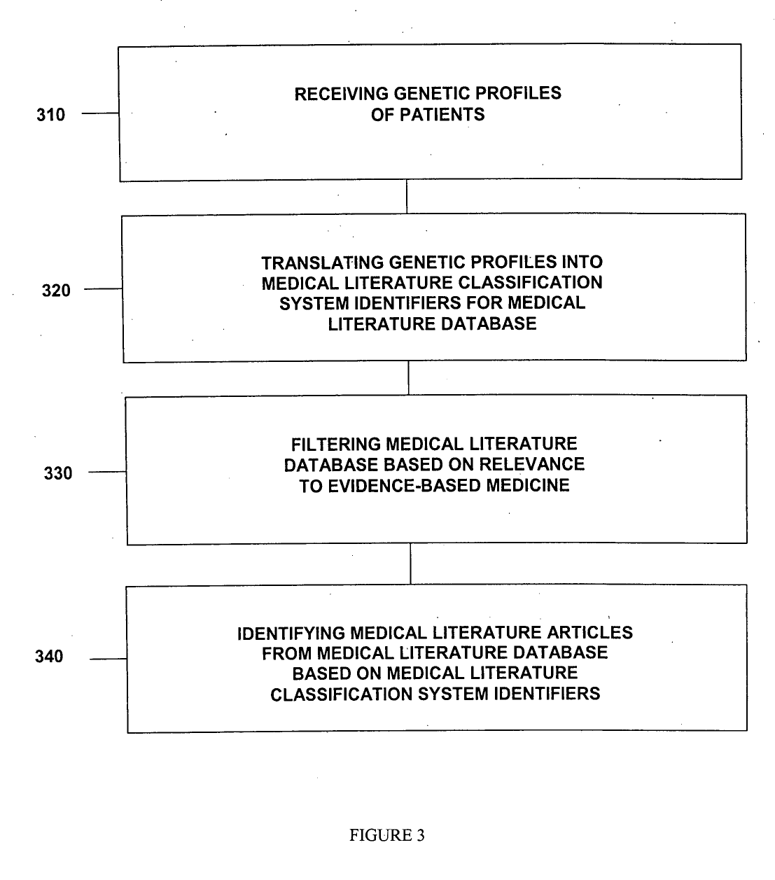

FIG. 3 shows another exemplary embodiment of identifying medical literature. In 310, genetic profiles of patients are received. In 320, genetic profiles are translated into medical literature classification system identifiers. In 330, a medical literature database is filtered based on relevance to evidence-based medicine. In 340, medical literature articles are identified from a medical literature database based on medical literature classification system identifiers. Various details of some embodiments follow below. Various embodiments add, delete, and modify portions of the claimed methods and apparatuses.

In some embodiments, physical findings of patients are received, and the physical findings are translated into medical literature classification system identifiers for a medical literature database.

One example of a nosology, or hierarchical classification of diseases, is ICD-9-CM, familiar to all US physicians. Other examples are SNOMED (Systematized Nomenclature of Medicine of the College of American Pathologists), ISCD (International Statistical Classification of Diseases and Related Health Problems of the World Health Organization), and CPT® (Current Procedural Terminology of the American Medical Association). Another disease classification system is patient diagnostic codes. Although many of discussions may apply a particular disease classification system, the concepts disclosed can be applied to all disease classification systems.

For a clinically intuitive organization of medicine, the public domain ICD-9-CM is one excellent choice. Unlike MEDLINE® and its MeSH terms that were developed as library instruments for the National Library of Medicine, the ICD has always been a tool for clinical medicine, and is familiar to any physician practicing in the United States.

One example of a medical literature classification system is MeSH, or Medical Subject Headings. MeSH is the index for MEDLINE®, the National Library of Medicine's comprehensive database of citations to the medical literature. Although many of discussions may apply a particular medical literature classification system, the concepts disclosed can be applied to all medical literature classification systems.

Examples of other related classification systems include BIOSIS®, DISEASEDEX™, DRUGDEX®, Faculty of 1000, National Guideline Clearinghouse™, Public Library of Science and PsycINFO.

Indexing and/or translation techniques translate disease classification system identifiers such as ICD-9-CM identifiers to medical literature classification system identifiers such as MeSH identifiers. Resources may be used such as the Unified Medical Language System (UMLS®), a project of the National Library of Medicine of the National Institutes of Health (NIH). Specific subject areas focuses can be focused, such as drug abuse.

The user interface is a feature in physician use of electronic clinical tools. ICD is hierarchically organized and can be linked to the hierarchically organized MeSH term by use of algorithms and tools within the UMLS® Metathesaurus®. The UMLS® Metathesaurus® contains information about medical concepts and terms from many different vocabularies and classifications. The Metathesaurus® preserves the names, meanings, hierarchical contexts, attributes, and inter-term relationships present in its source vocabularies and establishes new relationships between terms from different source vocabularies. The Metathesaurus® is a knowledge source of the UMLS® that contains information about biomedical concepts and terms from many controlled vocabularies and classifications. It can link the clinically intuitive ICD-9-CM with MeSH. An effective translation of ICD-9-CM to MeSH can combine UMLS® resources and other indexing/translation techniques. The ICD-9-CM nosology can be linked by the IND/UMLS® algorithm to MeSH for evidence-based medicine searches.

More comprehensive ICD-9-CM to MeSH translation and search functionality uses additional informatics technologies, resulting in demonstrated translation relevance to all medical disciplines. The search quality of medical literature database can be improved with tunability. An improved user interface uses advanced information design and visualization technologies.

On type of translation identifies UMLS® concept synonymy. MeSH terms sharing a Concept Identifier (CUI) with a source term from ICD-9-CM are identified. These terms from source vocabularies are translated to CUIs.

Another type of translation is the restricted-to-MeSH approach. A selected term's associated expressions are filtered for applicable MeSH terms, with analysis restricting more weakly related terms to preserve specificity. Terms close to the selected term within the ICD-9-CM hierarchy are evaluated. MeSH terms in expanded term set are identified. Non-hierarchically related ICD-9-CM terms are evaluated to identify MeSH terms.

A further type of translation uses normalized terms via the Normalized Index and other UMLS® lexical tools. The normalized index is a component of the SPECIALIST lexicon and is a knowledge source of the UMLS®.

Yet another type of translation uses terms stripped of qualifiers using the UMLS® Semantic Network to provide a result set using automated methods. The semantic network is a knowledge source of the UMLS® through its 134 semantic types. The semantic network provides a consistent categorization of all concepts represented in the UMLS® Metathesaurus®. 54 links between the semantic types provide the structure for the Semantic Network and represent important relationships in the biomedical domain.

Another type of translation uses hand-linked terms employing academic consultants for terms that resist provide a result set for analysis using other approaches for analysis.

The translation can be optimized for the purpose of bibliographic retrieval, such as acceptable specificity. The specificity may be adjusted based on evaluation of longer term user behavior, and/or even user input.

The various approaches can be combined and ordered, and the processing details of the various approaches can be determined by testing against various good result sets from various methods, including manual analysis by acknowledged experts in relevant subjects

MEDLINE® database schema can be modified as required, such as by adding and populating index and junction tables to implement translation and maintain search performance, and/or developing required stored procedures to provide front end code access to all database functionality.

The translation heuristic, including program and database code, can be developed and tested. ICD-9-CM terms which do not have UMLS® synonyms can be translated to MeSH terms, and normalized and qualifier-stripped term translation vis a vis MEDLINE® result sets with useful sensitivity/specificity characteristics can be implemented. The details of how the translations are coded, e.g. the relative order in which certain steps are performed in the processing of terms, can be optimized to produce good results. User-tuning of these procedural translations can occur. In some embodiments the processing flow cannot be optimized.

A test suite can use one or more of the following considerations.

To test a translation algorithm, input terms can be selected, for example at random, the algorithm applied, and then the relevance of the results evaluated. This procedure can rely on subjective judgments in the evaluation stage, since the reviewer considers only the input and known output of the algorithm. This subjectivity can be significantly reduced by choosing the right answers at the start of the project, before heuristic analysis begins.

Establishing the criteria before testing starts can result in detection of cases where the most optimal translation from ICD9-CM to MeSH was not identified. These missed target errors may be ignored using a post-test analysis procedure, where the only question considered is the relevance of the known result. Missed target errors also can be a criterion for evaluating EBM (evidence-based medicine) support.

The team of domain experts who create the test suite may or may not overlap the team who devises the translation heuristics. This may reduce the likelihood that the subjective assumptions of one or more individuals produces a biased evaluation.

When testing a candidate heuristic against a fixed test suite, the development team may strive to achieve a 100% success rate against the pre-selected tests. This can result in tuning the logic to fit the idiosyncrasies that are present in the limited set of test cases, yielding an algorithm that yields disappointing results in production use. Therefore reservation of a large varied portion of the test suite for the purpose of final evaluation only can be done, and some variation of test sets in successive development iterations provided.

Several different heuristic strategies can be developed. Each heuristic strategy can be tested against a partial test suite and enhanced, based on testing feedback. This feedback loop may continue through one or several iterations based, on the promise shown by each strategy.

Final versions of the most promising heuristics can be tested against reserved test cases.

Failing any viable translation heuristic, or in addition to a viable translation heuristic, a manual fixed translation of the Drug Dependence and Non-Dependent Use of Drugs term trees of ICD-9-CM can be accomplished by experts. Review by multiple experts and formal consensus can be employed to establish a degree of credibility of such a manual translation. This approach allows the rest of the project to proceed, such as development of an appropriate user interface and evidence-based medicine filtering. This same technique can be applied to other source nosologies such as CPT®, ICD, MeSH etc.

In other embodiments, received genetic profiles of patients are translated into medical literature classification system identifiers. A genetic profile can include a complete and/or partial genetic code, genetic sequence, and/or genome. The genetic profile can include single nucleotide polymorphisms, haplotype identifiers, and/or genetic proxies, such as biochemical and/or chemical proxies. Mapping may include MEDLINE® MeSH trees related to specific genes or gene sequences or other descriptors/proxies/markers of genetic sequences or features used to map to medical literature classification system identifiers.

Evidence-based medicine filters can be integrated to limit search results to relevant citations. Increasing the relevance of citations to evidence-based medicine will promote the use of evidence based medical literature among clinicians, and promote the use of evidence-based medicine among clinicians. Moreover, such efforts can be expected to produce public-health benefits.

Evidence-based medicine includes a formalized approach to informed diagnosis and treatment based on rigorous studies. Evidence based medicine includes the application of clinical evidence, for example clinical data provided in published clinical studies, by medical professionals to patients. Thus, tools for the practice of evidence based medicine, such as tools for retrieving materials for the practice of evidence based medicine, can have revolutionary benefits for patient care. Thus, such tools are very different from tools for industrial, research, biological, and bioinformatics applications.

Evidence-based medicine includes the integration of individual clinical expertise with the best available external clinical evidence from systematic research. Evidence-based medicine neither replaces clinical judgment nor is it a rationale for impersonal or utilitarian health policies. Scientifically rigorous medicine is critical to clinical advances and the well being of society as a whole.

Several filtering strategies qualify as evidence-based medicine. These vary in their appropriateness for specific uses based on factors such as specialty and subspecialty. Examples of specialties include medical oncology, radiation oncology, psychiatry, anesthesiology, cardiology, and pediatric oncology.

One or more of the following models can be employed. The user can be provided with the ability to adjust the sensitivity/specificity of the filtering employed in a given search. Several filtering strategies are listed. The Boolean logic from the evidence-based medicine filters can be implemented as selectable options:

The evidence-based medicine filter(s) can be used independently, integrated with the ICD-9-CM lexicon to refine search results to relevant citations. The filter options can be integrated with a search interface, search engine, and other functionality.

The simplified evidence-based medicine search filter is designed as a more generic filter, intended to provide simple screening of result sets to avoid overwhelming the user. The filter may be of special interest to physicians searching outside their primary specialty or specialty group

The McMaster University's Optimal Search Strategy, specificity optimized therapy and diagnosis search filter is one of the most widely accepted EBM filters, with existing links from within the standard National Library of Medicine interface to MEDLINE® (Entrez/Pubmed). This useful filter has parity with Entrez/Pubmed.

The University of York's statistically determined search filter was developed from an automated/statistical approach rather than by manually by human experts, providing a viable alternative approach.

The University of California, San Francisco's systemic review filter has existing links from within Entrez/Pubmed and is a useful filter for parity.

TABLE 1
Evidence-based Medicine Search Filters

| | |
|---|---|
| Evidence based | Selected MeSH term(s) AND {[Publication type: Clinical Trial, Phase III OR |
| medicine search | Clinical Trial, Phase IV OR Randomized Controlled Trial OR Meta-Analysis |
| filter | [quantitative summary combining results of independent studies] OR Review, |
| | Academic [comprehensive, critical, OR analytical review] OR Practice Guideline |
| | [for specific health care guidelines] OR [journal: cochrane database syst rev OR |
| | acp journal club OR health technol assess OR evid rep technol assess summ OR |
| | evid based nurs OR evid based ment health OR clin evid] NOT (case report [ti] OR |
| | case report [mh] OR editorial [ti] OR editorial [pt] OR letter [pt] OR newspaper |
| | article [pt]))} |
| McMaster | Selected MeSH term(s) AND {(double [word] and blind*[word]) OR placebo |
| University's | [word]} OR {osensitivity and specificityo[MeSH] or (predictive [word] AND |
| Optimal Search | value*[word])} |
| Strategy, | |
| specificity | |
| optimized | |
| therapy and | |
| diagnosis | |
| search filter | |
| The University | Selected MeSH term(s) AND {[Abstract: controlled OR design OR extraction OR |
| of York's | sources OR studies] OR [Publication type: randomized controlled trial OR meta- |
| statistically | analysis OR review] NOT [Publication type: letter OR comment OR editorial]} |
| developed | |
| specific search | |
| filter | |
| The University | Selected MeSH term(s) AND {((“systematic review*” OR “systematic literature |
| of California, | review*” OR meta-analysis [pt] OR meta-analysis [ti] OR metaanalysis [ti] OR |
| San Francisco's | meta-analyses [ti] OR evidence-based medicine OR (evidence-based AND |
| systemic review | (guideline [tw] OR guidelines [tw] OR recommendations)) OR (evidenced-based |
| filer | AND (guideline [tw] OR guidelines [tw] OR recommendation*)) OR consensus |
| | development conference [pt] OR health planning guidelines OR guideline[pt] OR |
| | cochrane database syst rev OR acp journal club OR health technol assess OR evid |
| | rep technol assess summ OR evid based nurs OR evid based ment health OR clin |
| | evid) OR ((systematic [tw] OR systematically OR critical [tw] OR (study [tiab] |
| | AND selection [tiab]) OR (predetermined OR inclusion AND criteri* [tw]) OR |
| | exclusion criteri* OR “main outcome measures” OR “standard of care”) AND |
| | (survey [tw] OR surveys [tw] OR overview* OR review [tw] OR reviews OR |
| | search* OR handsearch OR analysis [tw] OR critique [tw] OR appraisal OR |
| | (reduction AND risk AND (death OR recurrence))) AND (literature [tw] OR |
| | articles OR publications [tw] OR publication [tw] OR bibliography [tw] OR |
| | bibliographies OR published OR unpublished OR citation OR citations OR |
| | database OR internet [tw] OR textbooks [tw] OR references OR trials OR meta- |
| | analysis [mh] OR (clinical [tw] AND studies) OR treatment outcome)) NOT (case |
| | report [ti] OR case report [mh] OR editorial [ti] OR editorial [pt] OR letter [pt] OR |
| | newspaper article [pt]))} |

At least partly due to the filtering, identifying the one or more medical literature articles identifies evidence based medicine articles when used with a gold standard set of citations of evidence based medicine articles. The gold standard set of citations can be identified by a panel of experts.

Evidence based medicine articles can be identified with high specificity and high sensitivity. Specificity is the conditional probability of a negative test result given that the result is actually negative (that is, few false positives). Sensitivity is the conditional probability of a positive test result given that the result is actually positive (that is, few false negatives). High specificity can be at least 60%, at least 70%, at least 80%, at least 85%, at least 90%, or at least 95%. High sensitivity can be at least 60%, at least 65%, at least 70%, at least 75%, at least 80%, at least 85%, at least 90%, or at least 95%.

At least partly due to the filtering, identifying the one or more medical literature articles can approximate a gold standard set of citations of evidence based medicine articles. The gold standard set of citations can be identified by a panel of experts.

Expanded back end code can generate SQL queries from selected ICD-9-CM terms, evidence-based medicine filter, and/or other selected options. SQL, or Structured Query Language, is a standard database programming tool.

Various embodiments of the interface focus on physician information needs and user experience, rather than on theoretical informatics.

A manageable software/web user interface, uses state-of-the-art information design techniques and requires minimal or no training and minimal typing to search medical literature databases such as the MEDLINE® database.

The interface presented to users simplifies the retrieval of relevant medical literature. Various users, such as medical providers, can include: academic medical centers, HMO-based practices, hospital employees, chronic care facility employees, small group practices (e.g., 2-9 providers), large group practices (e.g., 10 or more providers), solo practitioners, residency/fellowship trainees, medical students, and other clinical trainees.

In some embodiments, a clinically intuitive tool for user selection of terms of a disease classification system can automatically identify the most relevant and current evidence-based medicine citations from a medical literature database such as MEDLNE®. The tool can be web-based with a web user interface, otherwise network based, or locally based. In some embodiments, a web resource allows medical care providers to access a medical literature database.

Web user interface elements hierarchically organize disease classification system identifiers, using diagnosis and/or procedure hierarchies. Web design components and information design techniques can enhance this interface. The interface simplifies selection of disease classification system identifiers, such as ICD-9-CM terms, selection of an evidence-based medicine (EBM) filter, and refinement of search parameters.

The users can visit to the library search page, perform search sets, view abstracts, view full text articles, spend time searching, save citations to personal folders

A web interface can be provided to a medical literature database such as MEDLINE® for a base of practicing physicians. Current MEDLINE® data is maintained, recast into a proprietary database schema, and a custom MeSH search engine executes queries against it. The site has a user interface with a look and feel streamlined to provide the most useful features of Entrez/PubMed targeted for practicing clinicians to access MEDLINE® citations.

Citations can be saved in users' online libraries for access from any web-enabled terminal. Users' online libraries provide for storage of queries and retrieved MEDLINE® citations. User-defined queries can be executed against MEDLINE® and can proactively send email to users if matches are found. Such auto queries can be set up to search MEDLINE® on a regular basis, e.g. weekly, for new citations that match user-selected criteria. The automatic email can optionally be sent to the user, notifying of new citations if any are found, or alternatively, the results can be stored in a user-accessible storage area, such as the user's online library. The ongoing automatic identification of quality citations based on user-defined criteria makes the tool all the more valuable. Users can customize result sets to the most current and relevant evidence-based medicine citations available on MEDLINE® for their specific interests and needs.

Addition of evidence-based medicine as a modality to access MEDLINE® can provide a useful complement. Expanded functionality can increase subscription rates and thereby increase advertising revenue, which will improve commercial viability and ensure the continuation of cost-free access to subscribers. The establishment of additional online journal clubs organized around AMA specialty designations provides a straightforward vehicle for commercialization.

Users can customize result sets to the most current and relevant evidence-based medicine citations available on medical literature databases such as MEDLINE® for their specific interests and needs, and have new citations that meet their search criteria identified automatically, and notification emailed to them proactively. Such a tool will increase health care providers' use of the medical literature.

Further, boards of editors, noted specialists in many subspecialties, can provide monthly recommendations for citations of particular relevance and quality to subscribers. Users can check the Editors' Choice Article of the Month and/or the online journal clubs where national experts select and review one article per period e.g. month in their subspecialty.

The tool can be free of charge to the user, or the tool can be associated with a cost, such as per search or per user, or per association.

Some embodiments include a revenue model based on advertising from medically relevant sponsors. Selected advertising can be of particular relevance to defined groups of subscribers. This establishes an exclusivity which adds value for both subscribers and advertising sponsors.

What is claimed is:

1. A method of identifying medical literature, comprising:
(a) searching a medical literature database by a computer using a medical literature classification system identifier for a disease integrated with an evidence based medicine search filter;
(b) searching a database of articles selected and reviewed by experts that concern the disease; and
(c) displaying results of the searches to the user.

2. The method of claim 1, wherein the medical literature database includes the National Library of Medicine's (NLM's) MEDLINE® database of citations.

3. The method of claim 1, wherein the medical literature classification system includes MeSH (MEDLINE®'s Major Subject Headings).

4. The method of claim 1, wherein the medical literature classification system includes BIOSIS®.

5. The method of claim 1, wherein the medical literature classification system includes DISEASEDEX™.

6. The method of claim 1, wherein the medical literature classification system includes DRUGDEX®.

7. The method of claim 1, wherein the medical literature classification system includes Faculty of 1000.

8. The method of claim 1, wherein the medical literature classification system includes National Guideline Clearinghouse™.

9. The method of claim 1, wherein the medical literature classification system includes Public Library of Science.

10. The method of claim 1, wherein the medical literature classification system includes PsycINFO.

11. The method of claim 1, wherein the evidence-based medicine filter uses at least a generic evidence-based medicine filter.

12. The method of claim 1, wherein the evidence-based medicine filter uses at least a McMaster University optimal search strategy evidence-based medicine filter.

13. The method of claim 1, wherein the evidence-based medicine filter uses at least a University of York statistically developed search evidence-based medicine filter.

14. The method of claim 1, wherein the evidence-based medicine filter uses at least a University of California San Francisco systemic review evidence-based medicine filter.

15. The method of claim 1, wherein the searching functions are performed through a software/web-based, software/network-based, or software/local user interface.

16. The method of claim 15, wherein the user interface elements hierarchically organize disease classification system identifiers, using diagnosis and/or procedure hierarchies.

17. The method of claim 1, wherein the user is a medical provider selected from the list consisting of an academic medical center, a HMO-based practice, a hospital employee, a chronic care facility employee, a small group practice, a large group practice, a solo practitioner, a residency trainee, a fellowship trainee, and a medical student.

18. The method of claim 1, wherein the articles include validated treatments.

19. The method of claim 1, further comprising:
making the one or more articles available to one or more medical professionals.

20. The method of claim 1, wherein the results of said searches are displayed on personal computer selected from the list consisting of a desktop, laptop, or a handheld device.

21. A computer readable medium comprising code implementing a method comprising:
(a) searching a medical literature database using a medical literature classification system identifier for a disease integrated with an evidence based medicine search filter;
(b) searching a database of articles selected and reviewed by experts that concern the disease; and
(c) displaying results of the searches to the user.

22. The method of claim 21, wherein the medical literature database includes the National Library of Medicine's (NLM's) MEDLINE® database of citations.

23. The method of claim 21, wherein the medical literature classification system is selected from the group consisting of MeSH, BIOSIS®, DISEASEDEX™, DRUGDEX®, Faculty of 1000, National Guideline Clearinghouse™, Public Library of Science, and PsycINFO.

24. The method of claim 21, wherein the evidence-based medicine filter is selected from the group consisting of a generic evidence-based medicine filter, a McMaster University optimal search strategy evidence-based medicine filter, a University of York statistically developed search evidence-based medicine filter, and a University of California San Francisco systemic review evidence-based medicine filter.
